(19) United States
(12) Patent Application Publication
(10) Pub. No.: US 2004/0262908 A1
(43) Pub. Date: Dec. 30, 2004

(54) Clip and clipboard

(76) Inventor: Yoshiaki Nobata, Tokyo (JP)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/490,797

(22) PCT Filed: Sep. 25, 2002
(86) PCT No.: PCT/JP02/09839

(30) Foreign Application Priority Data
Sep. 25, 2001 (JP) 2001-331653
Oct. 22, 2001 (JP) 2001-324263

(51) Int. Cl. B42D 9/00

(52) U.S. Cl. 281/42

(57) ABSTRACT

A clip that eliminates conventional drawbacks, such as bulkiness, and that has a sufficient clipping force, made of wire material and includes, an upper clip portion shaped so that it surrounds at least a front surface of an article, a lower clip portion shaped so that it surrounds at least a back surface of the article, and one or more pair of elastic bodies connecting the ends of the upper and lower clip portions. The elastic bodies include a pair of expansible and contractible elastic members shaped to extend from one of the respective ends of the upper and lower clip portions while holding articles, and are positioned along the rear surface thereof, and vertically extending portions connecting the ends of the elastic member.

### BACKGROUND OF THE INVENTION

1. Field of the Invention

The present invention relates to a clip and, more specifically, a basic structure of the clip and a clipboard or a folder using the clip.

2. Description of the Related Art

A clip that is the most publicly known is a so-called clothespin-type clip using a coil spring or the like and having a power point as a clamping portion and an operating portion for opening the clip positioned on the opposite sides with respect to a fulcrum. This type of clip can clamp a document or the like by a rotational force effected by the spring power. Alternatively, there is a clip formed of metal plate or the like into a substantially angular C-shape in side view, and clamping the document or the like by a closing force at the extremity thereof generated by a resilient force of the metal plate.

In the clip of substantially angular C-shape, various devices are exercised so that the operating portion for opening the clip does not take a space more than necessary when the object is clamped. As well-known clips in this structure, there is a so-called double clip, which is designed in such a manner that an operating portion formed of a linear member can be rotated to be parallel with the object to prevent it from taking much space, a clip having no operation portion and being formed of double-layered metal plate of substantially angular C-shape, which slides on and holds the object by the inner metal plate, and a clip having no operating portion for clamping and hence requiring a specific tool for opening the clip for clamping the document or the like. As another type of clip is a so-called gem clip, which is used for clamping a thin object, formed by bending a linear member or machining a plate member.

From the viewpoint of the thickness of the document or the like which can be clamped, in the clips in the related art, the limit of the thickness of the document which can be clamped is the width of open limit of the power point for the clothespin-type clip, and is the height of the back plate which serves as a fulcrum for the substantially angular C-shaped clip. Therefore, in many cases, these clips are provided in several sizes so as to cope with a collection of documents of various thicknesses, and hence the size of the clip varies proportional to the thickness in order to secure the clamping force.

From the viewpoint of the space required when the document is clamped, the clip that requires the least space is the one using the specific tool as described above. However, it has disadvantage in that the specific tool is needed separately when clamping, and it is necessary to provide the tools in various sizes corresponding to the size of the clip to be used. In particular, once the user removes this type of clip outside the office, for example, at the site of the meeting, he/she has to bring back the document in pieces unless he/she brings the tool with him/her, which is inconvenient. In addition, this type of clip is used only for thin documents since the clip of excessively large size is not practical from the viewpoint of the shape of the tool.

However, the clips in the related art, including the clothespin-type clip and the angular C-shaped clip, are fixed in height at the back plate and in opening width at the fulcrum, as described above. Therefore, when the document having a thickness smaller than the height or the opening width is clamped, the difference between the height and the thickness of the document takes a space more than necessary as a ledge.

Subsequently, from the viewpoint of a force required for opening the clip when clamping the object, all the clips in the related art are designed to open the jaws by pressing the operating portion for opening the clip, except for the clip that requires the specific tool, or the clip which clamps by being slid-in. Furthermore, the user has to open the clip from a state in which the extremities are completely closed at least to the extent that corresponds to the thickness of the object. In particular, when the document is thick, the user has to exert a large force. Furthermore, since the force required for opening the clip resists against a force to clamp the object itself, the larger the clamping force of the clip is, the larger the force required to open becomes.

From the viewpoint of attachability and detachability of the clip in the related art, while the clothespin-type clip or slide-in type clip can be attached and detached in one-touch operation, not to speak of the clip that requires the specific tool, the so-called double clip, which is the most generally used, requires the user to rotate both operating portions, which is a little troublesome.

From the viewpoint of damage to the document, such as marks of pressurization caused by being bound by the clip in the related art, the jaw of all the clips substantially rotates about a fulcrum, and the object is clamped by the linear or the dot portions at the extremities thereof, except for the gem clip. Therefore, a large force is exerted locally and, in particular, after thick document is clamped, it may leave a mark on the document as a dent.

From the viewpoint of the material of the clip in the related art, there is a disadvantage in particular in that the material that can be used is limited by its structural basis. In other words, it is necessary for any type of clip, except for the gem clip, to keep the least distance between the fulcrum and the power point. Therefore, plastic clips, which are low in material strength, have to be provided with a rib or increased in thickness of material in order to secure the flexural rigidity between the fulcrum and the power point, which results in increase in mass, and hence they are not suitable for clamping office documents.

From the viewpoint of manufacturing cost of the clip in the related art, every clip is provided in several sizes or various material thicknesses in accordance with the thickness of the document to be clamped. Therefore, since there are many types, the manufacturing cost increases accordingly. In addition, when there are several types of bound documents that are significantly different in thickness, the size of the clip varies depending on the thickness of the document, which undeniably gives undesirable appearance.

From the viewpoint of the configuration of the clip, since many of the clips in the related art are designed to clamp the object by their linear portions at the extremities as described above, the power points at the extremities are always linear, and the upper and lower jaws have to be always the same length for keeping the balance when clamping the document. In addition, since the document is clamped by the jaws being substantially rotated, the clip that exerts a force by being rotated in the perpendicular direction, such as a corner clip, is actually impossible.

### BRIEF SUMMARY OF THE INVENTION

The above-described disadvantages are inevitable in the clips in the related art due to their structure. The present invention is intended to provide a clip having a structure in which the disadvantages of the clips in the related art are solved at the same time.

In other words, the clip of the present invention does not vary significantly in configuration even when the thickness of the document varies. It can easily be attached and detached without using the specific tool, does not occupy a space more than necessary regardless the thickness of the document to be clamped, does not require a strong force for opening the clip, does not give damage to the document by the clamping force, does not occupy a large space even when it is formed of material which is low in strength, such as plastic, does not require a high manufacturing cost, and it can cope with a special configuration.

In order to achieve the above-described features, a molded body employed in the present invention as a structure of the clip includes a resilient member oriented in the vertical direction, expanding and contracting in the vertical direction, and giving a force for clamping the object to upper and lower jaws, and two upper and lower jaws forming an angle of about 90°, that is, substantially transverse or horizontal, or smaller with respect to the orthogonal or vertically oriented resilient member.

More specifically, the object of the present invention is achieved by a clip for clamping a given object, formed of linear material, and including an upper jaw to be located at least on the surface of the object, the upper jaw having a shape to surround part of the front surface of the object, a lower jaw to be located at least on the back surface of the object, the lower jaw having a shape to surround part of the back surface of the object, and a resilient member for connecting the end of the upper jaw and the end of the lower jaw, the resilient member formed so as to be positioned from the end of each of the upper jaw and the lower jaw along the backside thereof in a state in which the object is clamped.

In a further preferred embodiment, the upper jaw and the lower jaw are held at about 90° or smaller with respect to the resilient member when the object is not clamped.

The resilient member is preferably provided with rigidity against bending so that the upper jaw and the lower jaw are kept at about 90° with respect to the resilient member when the object is clamped.

In yet another preferable embodiment, at least a pair of resilient members are provided, and each resilient member includes a pair of elastic resilient portions and a connecting portion extending in the vertical direction for connecting the ends of the resilient portions.

The upper jaw and the lower jaw each may be a shape defining three sides of a rectangle, or the upper jaw and the lower jaw each may be a shape defining two sides of a triangle.

Furthermore, the pair of resilient members may be disposed at a predetermined angle, for example, at 90°. Accordingly, a so-called corner clip is obtained.

The advantages of the disclosed embodiments of the present invention are achieved by a clip for clamping a given object including a substantially plate-shaped upper jaw at least the inner surface of which is planer, a substantially plate-shaped lower jaw at least the inner surface of which is planer, and at least one or more resilient members formed of linear material and connecting a part of the upper jaw and the corresponding portion of the lower jaw, the resilient member formed so as to be positioned from the end of each of the upper jaw and the lower jaw along the backside thereof in a state of clamping the object.

In the preferred embodiment, the resilient member includes a pair of pressing portions extending from both ends at an angle of about 90° or smaller with respect to the resilient member itself for urging the upper jaw and the lower jaw toward each other.

The resilient member may be formed in the substantially vertical direction or orthogonal orientation on the backside. Preferably, the upper jaw and the lower jaw are held at about 90° or smaller with respect to the resilient member when the object is not clamped.

In yet a further preferred embodiment, the resilient member is provided with rigidity against bending so that the upper jaw and the lower jaw are held at about 90° with respect to the resilient member when the object is clamped. To do so, each of the upper jaw and the lower jaw may be provided with a flexural rigidity transmitting portion to transmit the flexural rigidity of the resilient member by coming into contact with the resilient member at least at one point. Alternatively, rigidity against bending may be provided to the upper jaw and the lower jaw by bending the backside ends thereof into a nested shape.

Another preferred embodiment includes at least a pair of resilient members, and the resilient members are formed of linear material and include a pair of expandable and contractible resilient portions and a connecting portion extending in the vertical direction for connecting the ends of the resilient portions.

The ends of the resilient member may be positioned in the vicinity of the ends of the upper jaw and the lower jaw, or the connecting portion of the resilient member may be positioned in the vicinity of the ends of the upper jaw and the lower jaw.

At least a pair of resilient members may be disposed at a predetermined angle. By setting the angle to about 90°, a so-called corner clip is achieved. In this embodiment, the upper jaw and the lower jaw may be formed into a triangle defined by two sides forming the above-described predetermined angle and a side connecting the ends of the two sides.

In another preferred embodiment, at least one of the upper jaw and the lower jaw includes an extending portion which is substantially flush with the upper jaw or the lower jaw on the backside in a state in which the object is clamped. The extending portion may be utilized as an index. The number of resilient members is not limited to one or two. For example, a plurality of pairs of the resilient members may be provided. Alternatively, the odd number of resilient members may be provided.

In another preferred embodiment, a projection is formed on part of the inner surface of one of the upper jaw and the lower jaw. A recess may be formed on the inner surface of the other one of the upper jaw and the lower jaw at the position so as to be fitted to the projection.

For example, at least one elongated projection along the direction of insertion of the object and/or an elongated recess along the direction perpendicular thereto is/are formed on the inner surface thereof. Alternatively, the plan shape of the projection may be substantially circular shape.

In addition, it is also possible to provide a projection on one of the inner surfaces and a recess on the other inner surface, and the cross-sectional shape of the projection is inclined in the direction of insertion and the cross-sectional shape of the recess provided on the other inner surface has a shape fitted to the projection.

Furthermore, in another embodiment of the present invention, a clipboard is constituted of the clip and a plate-shape base of a predetermined size for placing the object, to which the lower jaw of the clip is mounted.

In a clipboard according to another embodiment, the base for placing the object may be formed by extending the lower jaw of the clip to a plate shape of the predetermined size.

### BRIEF DESCRIPTION OF THE DRAWINGS

FIG. 1 is a perspective view of a clip according to a first embodiment of the present invention.

FIG. 2 is a cross-sectional view showing a state in which the clip according to the first embodiment is opened to clamp a object.

FIG. 3 is a cross-sectional view showing a state in which the clip according to the first embodiment is clamping the object.

FIG. 4 is a perspective view showing a state in which a resilient member is expanded and the object is clamped in the first embodiment.

FIG. 5 is a perspective view of a clip according to a second embodiment.

FIG. 6 is a plan view of a clip according to a third embodiment.

FIG. 7 is a back view of the clip according to the third embodiment, when nothing is clamped.

FIG. 8 is a cross-sectional view taken along the line VIII-VIII in FIG. 7 showing the clip according to the third embodiment when nothing is clamped.

FIG. 9 is a back view of the clip according to the third embodiment when the object is clamped.

FIG. 10 is a cross-sectional view taken along the line X-X in FIG. 9 showing a state in which the clip according to the third embodiment is clamping the object.

FIG. 11 is a cross-sectional side view of a clip 200a according to a fourth embodiment.

FIG. 12 shows a jaw and a resilient member of the clip according to the third embodiment, in which FIG. 12A to FIG. 12C are cross sectional views taken along the line B-B, the line C-C, and the line D-D in FIG. 7 respectively, and FIG. 12D is a partial back view of the resilient member.

FIG. 13 is a plan view of a clip according to a fifth embodiment.

FIG. 14 is a back view of the clip according to the fifth embodiment when nothing is clamped.

FIG. 15 is a cross-sectional view taken along the line XV-XV in FIG. 14, showing the clip according to the fifth embodiment when nothing is clamped.

FIG. 16 is a back view showing a state in which the clip according to the fifth embodiment is clamping an object.

FIG. 17 is a cross-sectional view taken along the line XVII-XVII in FIG. 16, showing a state in which the clip according to the fifth embodiment is clamping the object.

FIG. 18 is a cross-sectional view taken along the line XVIII-XVIII in FIG. 26, showing a clip according to a sixth embodiment when nothing is clamped.

FIG. 19 is a back view of a clip according to a seventh embodiment.

FIG. 20 is a plan view showing another example of the clip according to the present invention.

FIG. 21 is a side view of the clip shown in FIG. 20.

FIG. 22 is a plan view showing another example of the clip according to the present invention.

FIG. 23 is a plan view showing still another example of the clip according to the present invention.

FIG. 24 is a plan view showing an example of a clip board using the clip according to the present invention.

FIG. 25 is a back view of a modification of the clip according to the third embodiment.

FIG. 26 is a back view of the clip according to the sixth embodiment.

FIG. 27 is a back view showing a modification of the clip according to the sixth embodiment.

FIG. 28 is a perspective view partly in cross section, showing another example of the clip according to the present invention.

FIG. 29 is a perspective view partly in cross section showing still another example of the clip according to the present invention.

FIG. 30 is a front view of a clip according to an eighth embodiment.

FIG. 31 is a back view of the clip according to the eighth embodiment.

FIG. 32 is a partial cross section of the clip according to the eighth embodiment.

FIG. 33 is an explanatory perspective view showing a state in which the clip according to the eighth embodiment is used.

FIG. 34 is a side view showing a state in which the clip according to the eighth embodiment is about to clamp the object.

FIG. 35 is a side view showing a state in which the clip according to the eighth embodiment clamps the object.

FIG. 36 is a back view showing a state in which the clip according to the eighth embodiment is clamping the object.

FIG. 37 is a front view of a clip corresponding to a modification of the eighth embodiment.

FIG. 38 is a back view of a clip corresponding to the modification of the eighth embodiment.

FIG. 39 is a side view of the clip corresponding to the modification of the eighth embodiment.

FIG. 40 is a plan view of a corner clip of the present invention as still another modification.

FIG. 41 is a partial cross-sectional view of the corner clip as still another modification.

FIG. 42 is a partial cross section of the clip according to the present invention as a further modification.

FIG. 43 is a partial cross section of the clip according to the present invention as a still further modification.

### DETAILED DESCRIPTION OF THE INVENTION

Referring now to the attached drawings, the structure and the usage of a clip according to the present invention will be described.

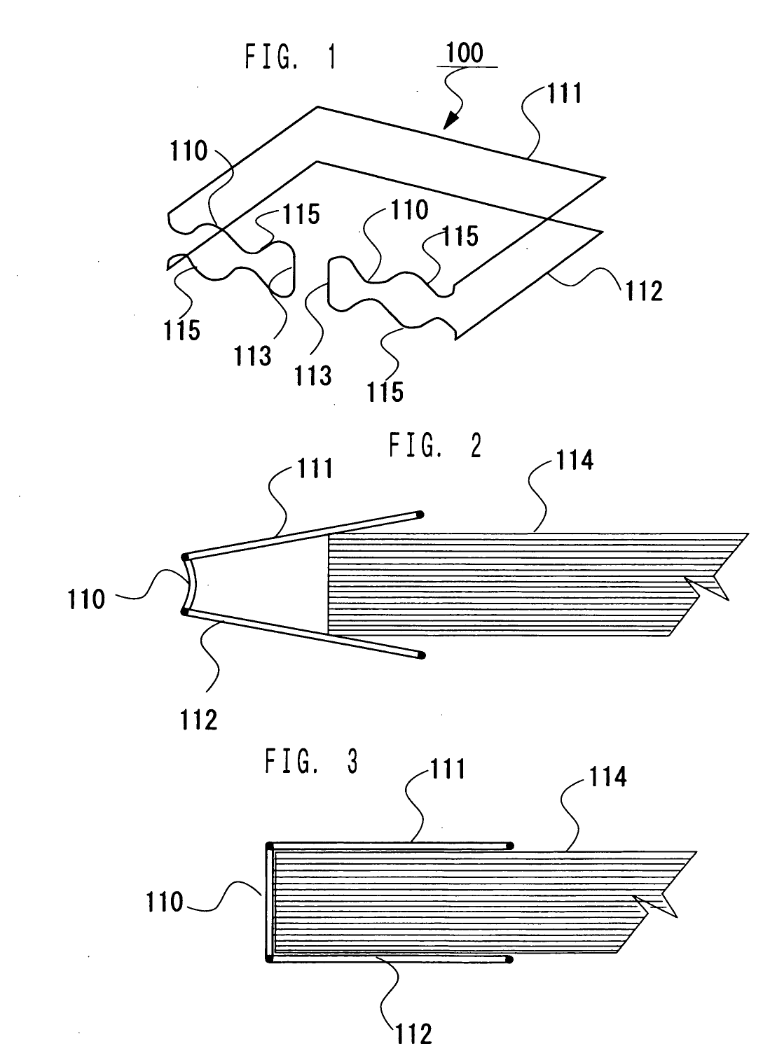

FIG. 1 is a perspective view of a clip according to a first embodiment of the present invention. The first embodiment is a clip formed only of a resilient metal wire based on the structural principal of the present invention, in which the principal of the present invention is shown most comprehensively.

As shown in FIG. 1, a clip 100 according to the present embodiment includes an upper jaw 111 and a lower jaw 112 extending in substantially mutually parallel relationship. As shown in FIG. 1, the upper and lower jaws 111, 112 are oriented horizontally, and resilient members 110, 110 extend vertically and expand and contract in the vertical direction, that is, the resilient members are oriented to be orthogonal to the plane of the upper and lower jaws 111, 112.

As shown in FIG. 1, the upper jaw 111 and the lower jaw 112 each has a shape corresponding to three sides of a rectangle. The resilient members 110 are continuing from the respective ends thereof to connect the upper jaw 111 and the lower jaw 112. In the first embodiment, the resilient members 110 are connected to the end of each of the upper jaw 111 and the lower jaw 112, respectively, and include resilient portions 115, 115 having a restoring force so as to align with the planes defined respectively by the upper jaw 111 and the lower jaw 112, and a connecting portion 113 extending perpendicular (vertically as shown in FIG. 1) with respect to the planes of the jaws 111, 112 and connecting the other ends of the resilient portions 115, 115.

The clip 100 according to the present embodiment, being different from the clip in the related art, keeps the opened state as shown in FIG. 1, that is, the upper jaw 111 and the lower jaw 112 extend substantially in parallel at a distance corresponding to the length (height) of the connecting portion 113 apart from each other when nothing is clamped. While the thickness of the object to be clamped is limited to the height of the back plate in the related art, the object of any thickness can be clamped by the clip 100 according to the present embodiment as long as the capability of the resilient member 110 allows, provided that the thickness of the object exceeds the height of the resilient member 110 (that is, the length of the connecting portion 113), which corresponds to the back plate of the clip in the related art.

A case in which a object 114 is clamped by the clip 100 according to the present embodiment will be described below. The user opens first the upper jaw 111 and the lower jaw 112 away from each other by hand. In this case as well, a required opening force is not a force resisting against the clamping force itself as in the related art, but a force against the bending force of the resilient member 110 having a surface rigidity as shown in FIG. 2, and is much smaller than the clamping force. At this time, since the upper jaw 111 and the lower jaw 112 are opened by being rotated about the vertical center of the resilient members 110, the extremities thereof can be opened to a sufficient extent even when the angle at the proximal side of the upper jaw 111 and the lower jaw 112, that is, on the side connected to the resilient members 110, is small. In addition, according to the clip 100 of the present embodiment, since the user only has to open the upper jaw 111 and the lower jaw 112 by an extent corresponding to the difference between the thickness of the object 114 and the distance between the upper jaw 111 and the lower jaw 112, the user can open much easier in comparison with the clip in the related art, in which the user must open by an extent corresponding to the thickness of the object.

When the distance by an extent that the object 114 can be inserted is secured in this manner, the user presses the object 114 therein until the end thereof reaches the resilient members 110. At this time, the thickness of the object 114 widens the distance between the upper jaw 111 and the lower jaw 112, and expands the resilient members 110 simultaneously. When the resilient members 110 are expanded and the heights thereof reach the thickness of the object 114, the upper jaw 111, the lower jaw 112, and the front surface and the back surface of the object are aligned in parallel with each other as shown in FIG. 3. Then, a contracting force of the resilient members 110 is transmitted to the upper jaw 111 and the lower jaw 112, and the upper jaw 111 and the lower jaw 112 come into tight contact with the object 114. Consequently, the object 114 is clamped by the lower surface of the upper jaw 111 and the upper surface of the lower jaw 112 as a whole.

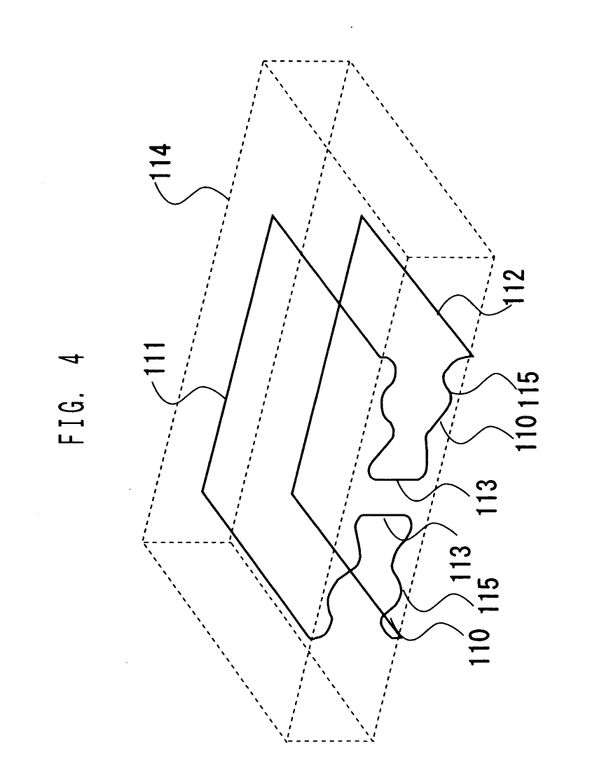

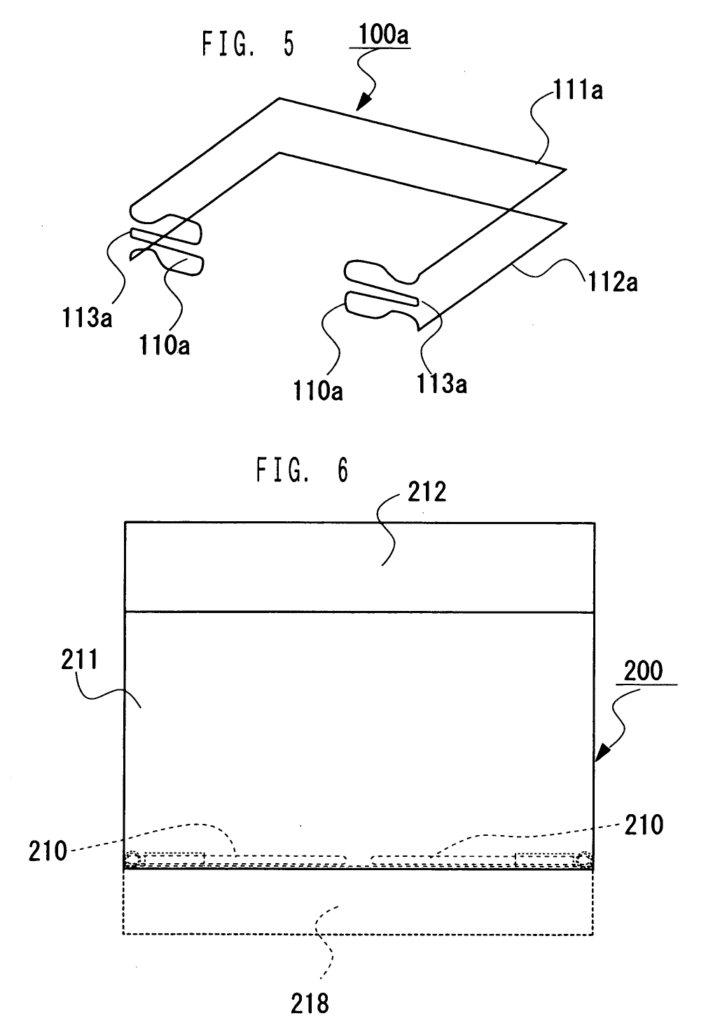

FIG. 4 is a perspective view showing a state in which the resilient members 110 are expanded and the object 114 is clamped. As shown in FIG. 4, the distance between the upper jaw 111 and the lower jaw 112 becomes greater than the initial state (See FIG. 1) by clamping the object 114, and correspondingly, the resilient portions 115 of the resilient members 110 are expanded outwardly. At this time, a force urging the upper jaw 111 and the lower jaw 112 toward each other is generated by a restoring force of the resilient portions 115, which acts as a clamping force.

When removing the clip 100 from the object 114, what has to be done by the user is just to hold the object 114 with one hand, and pull out the clip 100.

FIG. 5 is a perspective view of a clip according to the second embodiment. In this clip 100a, the configuration of the connecting portion differs from that in the first embodiment. As shown in FIG. 1, when the connecting portions 113 for connecting the resilient portions 115 connected to each end of the upper jaw 111 and the resilient portions 115 connected to each end of the lower jaw 112 are provided substantially at the center of the clip 100, the distance between the upper jaw 111 and the lower jaw 112 can be reduced. However, there is a possibility that twisting may occur around that point, whereby the upper jaw 111 and the lower jaw 112 may be displaced with respect to each other. The configuration shown in FIG. 1 has a sufficient clamping force as a clip for clamping the thin object, and hence it can be used without problem. However, when attempt is made to clamp a thick object, the jaws rotate and are displaced, thereby becoming unstable. In order to prevent such phenomenon, according to the second embodiment, connecting portions 113a are disposed in the vicinity of both ends of an upper jaw 111a, and a lower jaw 112a, and hence the upper jaw 111a and the lower jaw 112a can clamp the object with no displacement, that is, less twisting. Therefore, stable clamping is achieved also in the case where a relatively thick object is clamped.

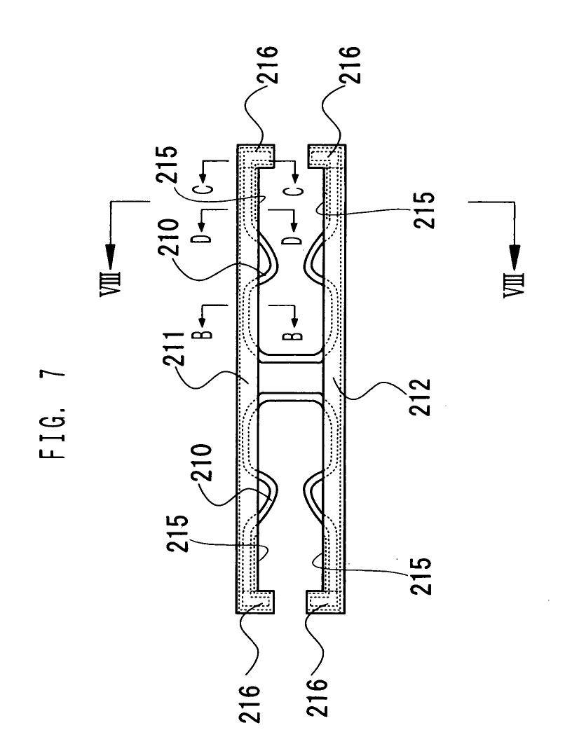

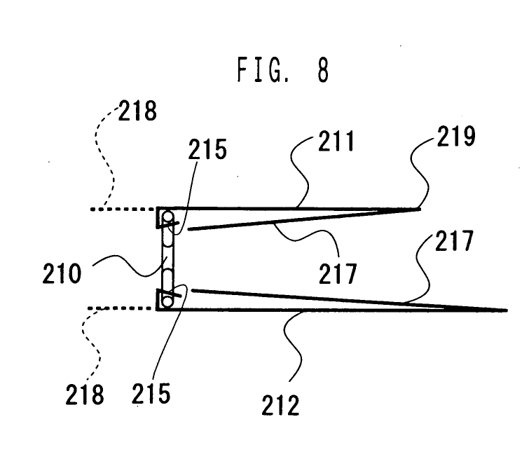

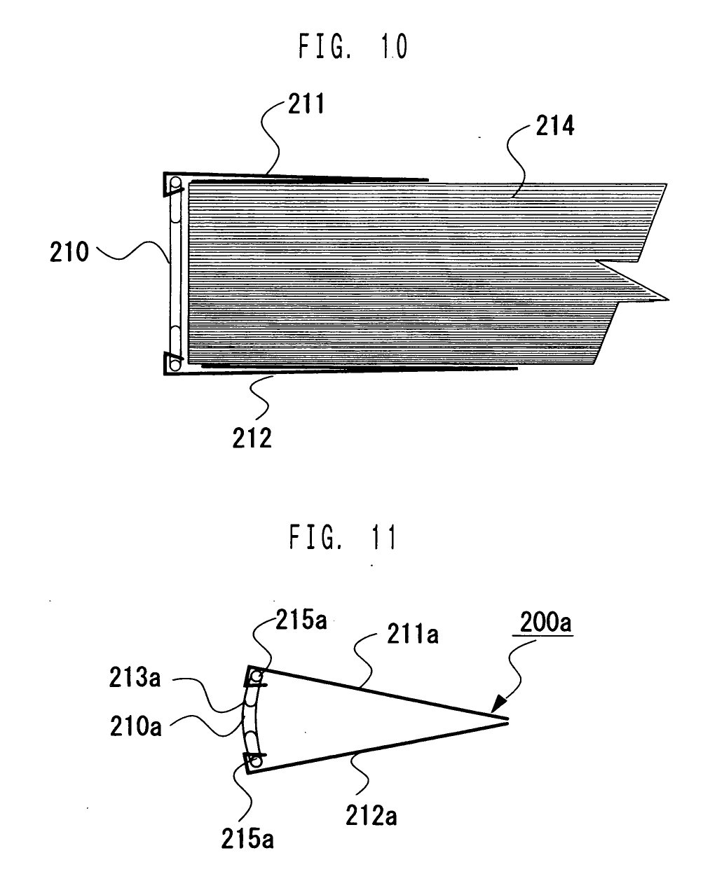

Subsequently, referring to FIG. 6 to FIG. 10, and FIG. 12A to FIG. 12D, a third embodiment of the present invention will be described. FIG. 6 is a plan view of a clip according to the third embodiment, FIG. 7 and FIG. 8 are a back view and a cross-sectional side view of the clip in a state in which nothing is clamped. A clip 200 according to the third embodiment includes an upper jaw 211 and a lower jaw 212 formed of material such as plastic or metal into a plate shape completely separated from each other, and resilient members 210, 210 connecting the upper jaw 211 and the lower jaw 212 of a plate shape with each other and serving also as a spring. The resilient members 210 are each formed by bending a metal wire for defining a plane.

As shown in the drawings, the third embodiment is a basic example showing an ideal clip structure that occupies the least space, that is, the upper jaw 211 and the lower jaw 212 project from the front surface and the back surface of a object 214, respectively, only to the extent corresponding to the thickness of the upper jaw 211 and the lower jaw 212 when the object is clamped, irrespective of the thickness of the object.

In this clip 200, a vertical force of expansion and contraction of the resilient members 210, 210 is transferred to the upper jaw 211 and the lower jaw 212 provided separately. Therefore, there are provided clamping force transmitting portions 215 along one side of each of the backsides of the upper jaw 211 and the lower jaw 212, respectively. The clamping force transmitting portions 215 are formed at the ends of each of the backsides of the upper member 211 and the lower member 212 into an “angular C-shape” in cross section as shown in FIG. 12B, so that the front side, that is, the side where the object is to be inserted is opened. In the present embodiment, the two clamping force transmitting portions 215 are formed at the ends on the backside along one-fourth the length of the backside. This length can be changed according to the configuration of the resilient member 210, as a matter of course. Furthermore, it is also possible to eliminate these clamping force transmitting portions 215, and to provide a clamping force transmitting capability to a rigidity transmitting portion 216, that will be described later, so that both capabilities are achieved by one single device. In particular, in the case of the clip the width of the jaw of which is small, since the width (length in the horizontal direction) of the resilient member 210 is small, employing such configuration is effective.

In contrast, in the present embodiment, as shown in FIG. 12A, a cross-sectional shape of center portions of the upper jaw 211 and the lower jaw 212 are configured to be opened on two sides. Therefore, when attempt is made to clamp the object, the resilient members 210 can expand in the direction indicated by an arrow X as will be described later.

Provided at both ends of each of the upper jaw 211 and the lower jaw 212 are the rigidity transmitting portions 216 for transmitting flexural rigidity of the resilient members 210 to the upper jaw 211 and the lower jaw 212 respectively so as to prevent the upper jaw 211 and the lower jaw 212 from rotating and opening. As shown in FIG. 12C and FIG. 12D, the rigidity transmitting portions 216 are cylindrical each opened on top and bottom, so that ends 222 of the resilient members 210 bent perpendicularly with respect to the planes of the upper jaw 211 and the lower jaw 212 are stored in the cylinder. While the flexural rigidity is transmitted by restraining the perpendicularly extending resilient bodies 210 by the upper jaw 211 or the lower jaw 212 in the present embodiment, the mode or the method of transmission can be modified depending on the configuration of the resilient members 210 as a matter of course.

The resilient member 210 includes the end portions 222 bent in the perpendicular direction at both ends, a horizontal portion 221 which continues from the end 222 and comes into contact with the clamping force transmitting portion 215 of the jaw, resilient portions 223 which are to be expanded when the object is clamped, and a connecting portion 213 extending perpendicularly for connecting the upper and lower resilient portions 223.

The clip 200 according to the present embodiment further includes force exerting portions 217, 217 formed by bending the front ends, that is, the ends which are not provided with the resilient members 210, of the upper jaw 211 and the lower jaw 212 inwardly for increasing the clamping force and preventing the upper jaw 211 and the lower jaw 212 from opening, as shown in FIG. 8. The force exerting portions 217 are configured in such a manner that the force exerting portion 217 connected to the upper jaw 211 is urged in the direction away from the upper jaw 211 and the force exerting portion 217 connected to the lower jaw 212 is urged in the direction away from the lower jaw 212, both about the bent positions (See reference numeral 219). The force exerting portions 217 may be formed, for example, of metal plate thinner than the upper jaw 211 and the lower jaw 212.

If the flexural rigidity can be transmitted sufficiently and reliably, and the object is always held in the direction of 90° with respect to the resilient members 210 when being clamped by the upper jaw 211 and the lower jaw 212, it is not necessary to provide the force exerting portions 217, as a matter of course.

In the clip 200 according to the present embodiment, the length of the upper jaw 211 differs from the length of the lower jaw 212 in the fore-and-aft direction (the direction of insertion of the object). It is for facilitating opening of the upper jaw 211 by pressing the lower jaw 212 having a longer length by the bottom surface of the object 214 when clamping the object 214. It is to be understood that the lengths in the fore-and-aft direction of the upper jaw 211 and the lower jaw 212 may be the same, as a matter of course.

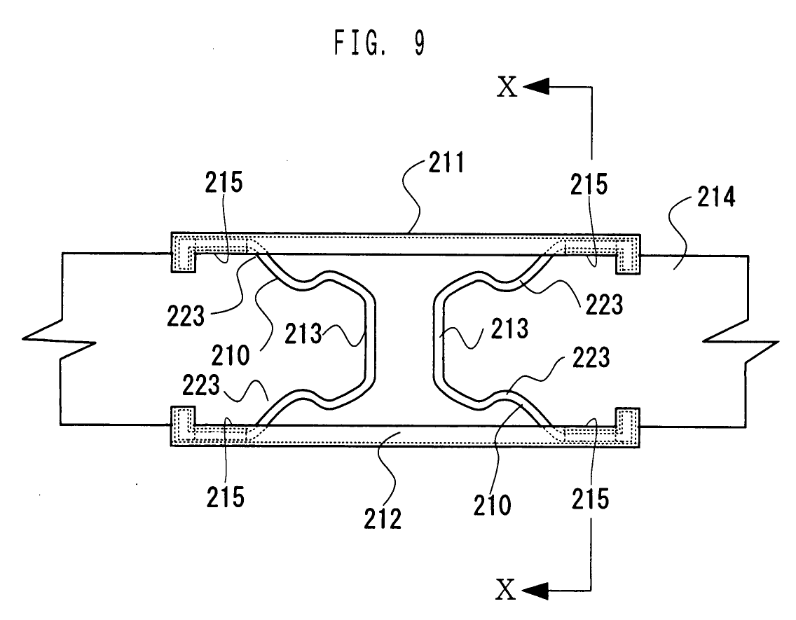

When using, the user presses the inner surface (the surface of the force exerting portion, if it is provided with the force exerting portion 217) of the lower jaw 212 with the bottom surface of the object 214 as described above, and then, opens the upper jaw 211 upwardly as needed, and then slides the object 214 therebetween. As the object 214 advances toward the back side of the clip 200, a force to move the resilient portions 223, 223 opposed with the intermediary of the connecting portion 213 in the direction away from each other is exerted as shown in FIG. 9. At this time, since the resilient portions 223, 223 are provided with a spring force working in the direction toward each other, the spring force is transmitted to the upper jaw 211 and the lower jaw 212 via the clamping force transmitting portions 215, 215. Therefore, as shown in FIG. 10, the object 214 can be fixedly clamped by the inner surfaces of the upper jaw 211 and the lower jaw 212 (surfaces of the two force exerting portions 217, 217, if they are provided).

As a modification of the above-described embodiment, it is also possible to extend the backsides of the upper jaw 211 and the lower jaw 212 of the clip 200 and provide operating portions 218, 218 to open the extremities of the clip 200. This is shown in FIG. 6 and FIG. 8 by broken lines. Although it is not necessarily required to provide the operating portions 218, this can be utilized in various ways such as an index. When the operating portions 218 are provided, the operating portions 218 project so as to align in parallel with the front surface and the back surface of the object, when the object is bound. Since the operating portions of the clip in the related art are extending obliquely with respect to the surfaces of the object, it is not practical to use the operation portion as an index. However, according to the above-described embodiment, the usage of the clip as an index is realized.

According to the first to third embodiments, the upper jaw and the lower jaw are configured to extend substantially in parallel with each other in the initial state, that is, when the object is not clamped. However, it is not limited thereto, and the extremities thereof can be substantially closed in order to enhance the clamping force. FIG. 11 is a cross-sectional side view of a clip 200a according to a fourth embodiment. As shown in FIG. 11, according to the fourth embodiment, connecting portions 213a of resilient members 210a are preferably curved backwardly, so that the angles formed by an upper jaw 211a and a lower jaw 212a with respect to the resilient bodies 210a are about a right angle respectively around the portion where they come into contact with respect to each other. In this arrangement, the inner surfaces of the jaw 211a and the jaw 212a can come into tight contact with the front surface and the back surface of the object when the object is clamped.

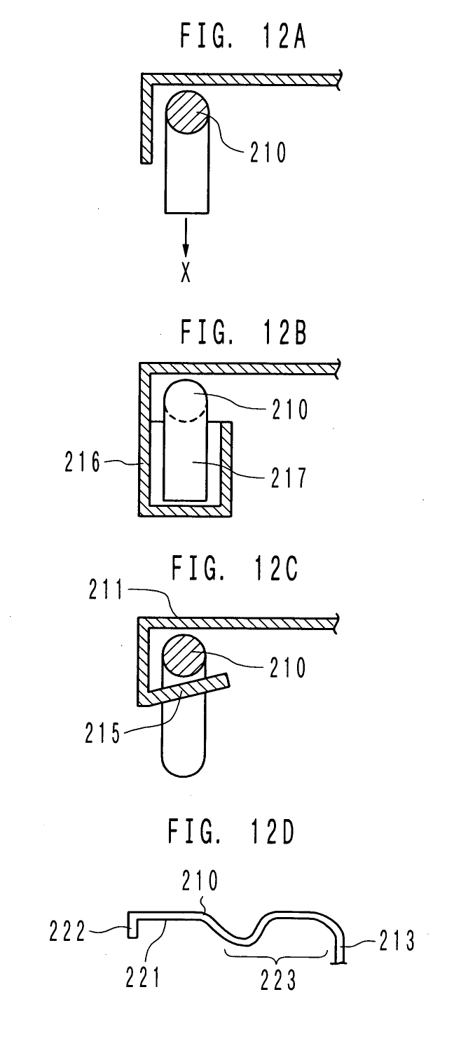

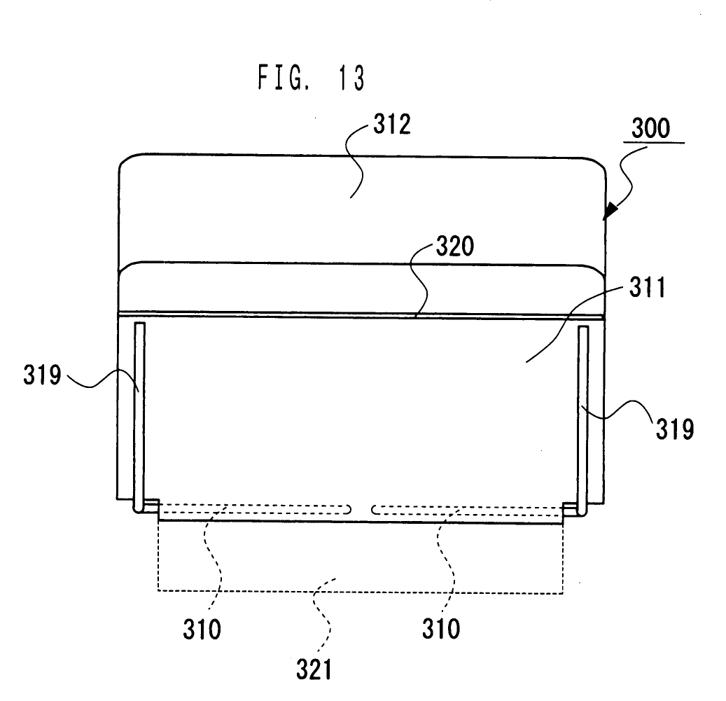

Subsequently, a fifth embodiment of the present invention will be described. FIG. 13 is a plan view of a clip according to the fifth embodiment. FIG. 14 and FIG. 15 are a back view and a cross-sectional side view, respectively, of the clip when nothing is clamped. As shown in the drawings, a clip 300 according to the fifth embodiment includes an upper jaw 311 and a lower jaw 312 formed of plate-shaped material such as plastic or metal and separated completely, and linear members 322 including resilient members 310, 310 formed of metal wire for connecting the upper jaw 311 and the lower jaw 312 and acting as a spring, and jaw pressing portions 319, 319, 319, 319 extending from the respective ends of the resilient members 310 along the outer surfaces of the upper jaw 311 and the lower jaw 312.

In the clip 300 of the present embodiment, the clamping force is maintained by the resilient members 310 and the jaw pressing portions 319. The upper jaw 311 and the lower jaw 312 are members for transmitting a clamping force to the object uniformly as a plane. Therefore, the upper jaw 311 and the lower jaw 312 require only the least thickness for the above-described function, that is, for transmitting the clamping force. Accordingly, even when plastic is used as a material for the upper jaw 311 and the lower jaw 312, the thickness can be reduced to the minimum extent, and hence a clip which does not occupy a large space can be provided. In addition, since the object is not clamped by the portion near the extremities, it is also possible to form the clip in various shape utilizing the advantage of the plastic material.

As shown in FIG. 14 and FIG. 15, the upper jaw 311 and the lower jaw 312 according to the present embodiment are formed with grooves 330 along the inner surfaces on the back sides thereof, so that the resilient member 310 can be stored in the grooves 330. It is also possible to form grooves on the outer surfaces of the upper jaw 311 and the lower jaw 312 for storing the jaw pressing portions 319 in the fore-and-aft direction so that at least part of the jaw pressing portions 319 are embedded therein. For example, by embedding the jaw pressing portions 319 completely, and visually hiding them from the outside, the design of the clip can be improved.

In addition, according to the fifth embodiment, as in the case of the third embodiment, the length of the lower jaw 312 in the fore-and-aft direction is longer than the upper jaw 312. However, it is not limited thereto, and the length of the upper jaw 311 and the lower jaw 312 in the fore-and-aft direction may be the same, as a matter of course.

According to the fifth embodiment, as shown in FIG. 15, the upper jaw 211 is formed with a bent groove 320 in the lateral direction, that is, in the direction perpendicular to the fore-and-aft direction, on the side of the extremity, and the upper jaw 311 is bent outward on the side of the extremity. It is provided for facilitating insertion of the object 314. However, it is not necessarily required to provide such a groove, and the extremity of the jaw may be formed of more flexible material, or may be designed so as to be opened by a force against the flexural resistance of the resilient member 310 as in the case of the first embodiment.

As shown in FIG. 13 and FIG. 15 by broken lines, it is possible to provide an operating portion 321 by extending the back side of the upper jaw 311 or of the lower jaw 312. The operating portion 321 may be provided on one of the jaws, or on both of the jaws. They can be used as index as in the case of the third embodiment. Furthermore, since the shape and the color thereof can be selected as desired when the jaws are formed of plastic material, its practicability is improved.

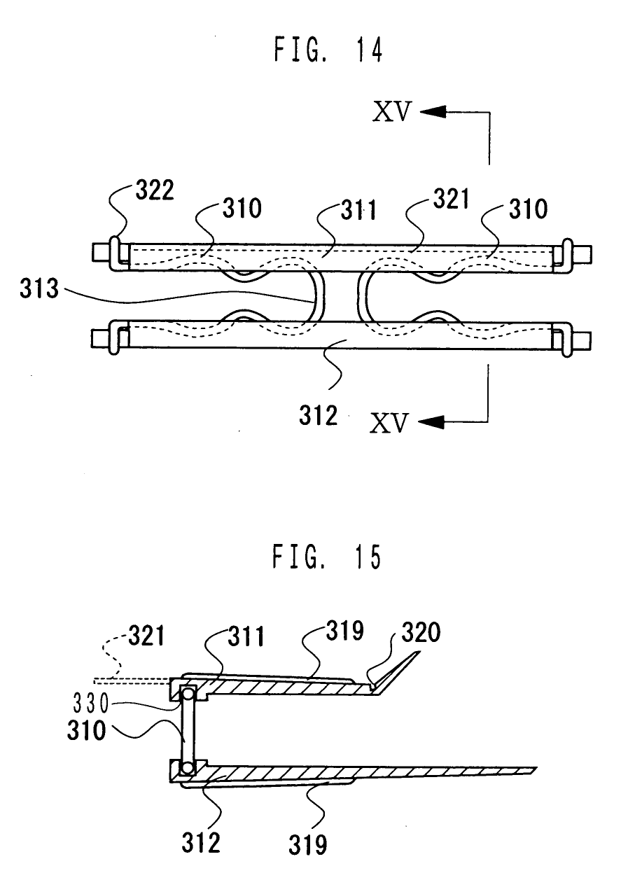

The operation for using this clip is the same as the case of the first to the fourth embodiments. When the object 314 advances toward the back side, a force is exerted in the direction to move opposed resilient portions 323, 323 of the resilient member 310 connected by a connecting portion 313 in the direction away from each other, as shown in FIG. 16. At this time, since the resilient portions 323, 323 have a spring force directing toward each other, this force is transmitted to the upper jaw 311 and the lower jaw 312 via the jaw pressing portion 319. Therefore, as shown in FIG. 17, the object 314 can be fixedly clamped by the inner surface of the upper jaw 311 and the lower jaw 312.

FIG. 18 is a cross-sectional side view of a clip according to a sixth embodiment. As shown in FIG. 18, a clip 300b is configured to clamp a smallest unit of object, that is, a single piece of paper, for example. This is achieved by setting the distance between the inner surface of an upper jaw 311a and the inner surface of a lower jaw 312a to substantially zero.

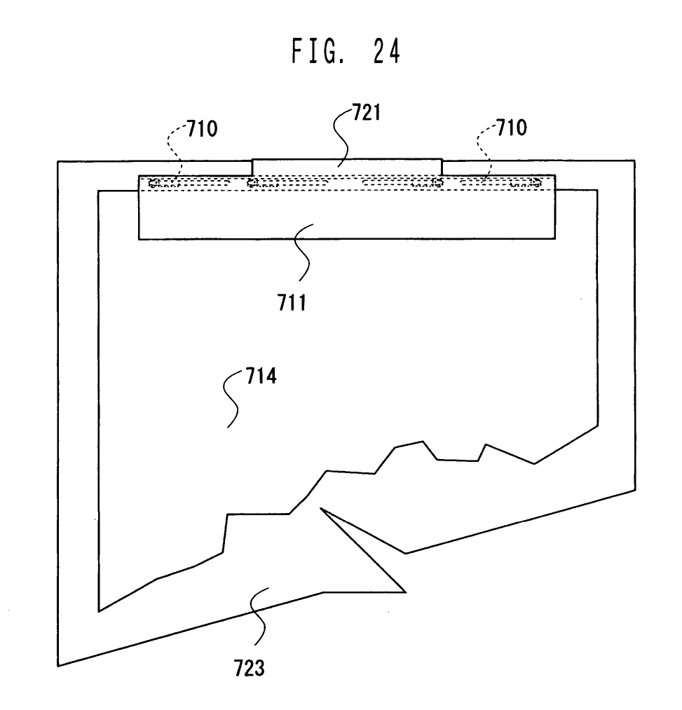

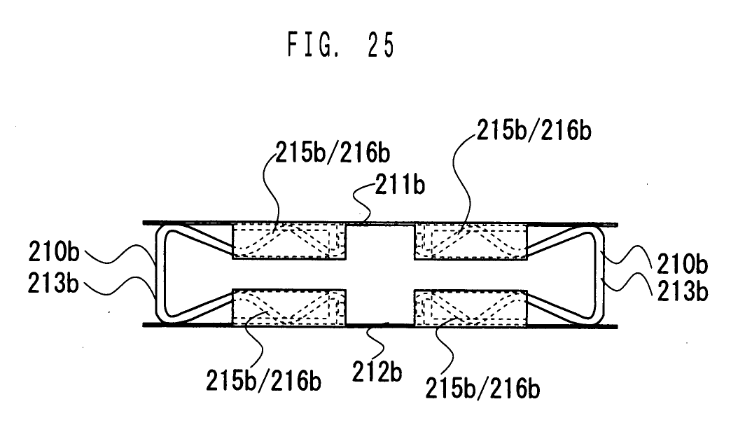

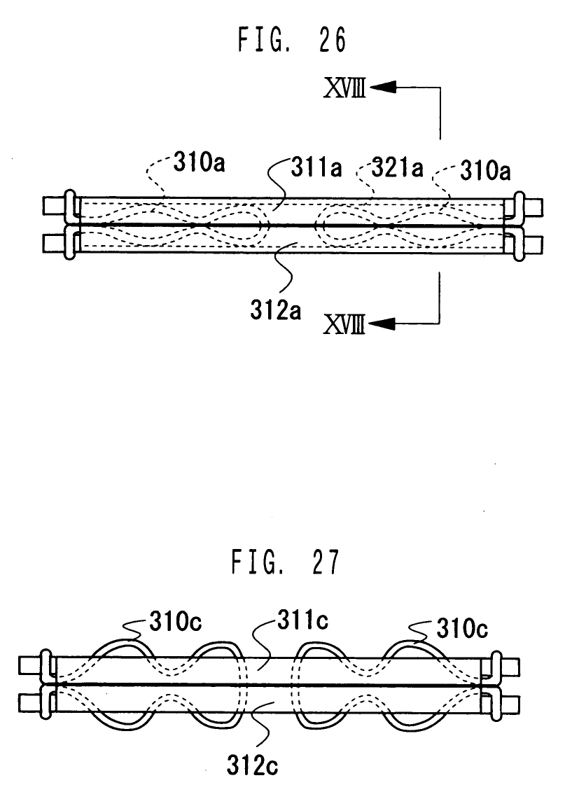

In this example, as shown in FIG. 26, resilient members 310a may have a height smaller than the thickness of the upper jaw 311a and the lower jaw 312a. Alternatively, in order to improve the capability of the resilient member, it is also possible to employ a configuration in which the resilient members 310a are partly projecting from an upper jaw 311c and a lower jaw 312c as shown in FIG. 27. In this case, holes for allowing resilient members 310c to penetrate are formed on the backsides of the upper jaw 311c and the lower jaw 312c.

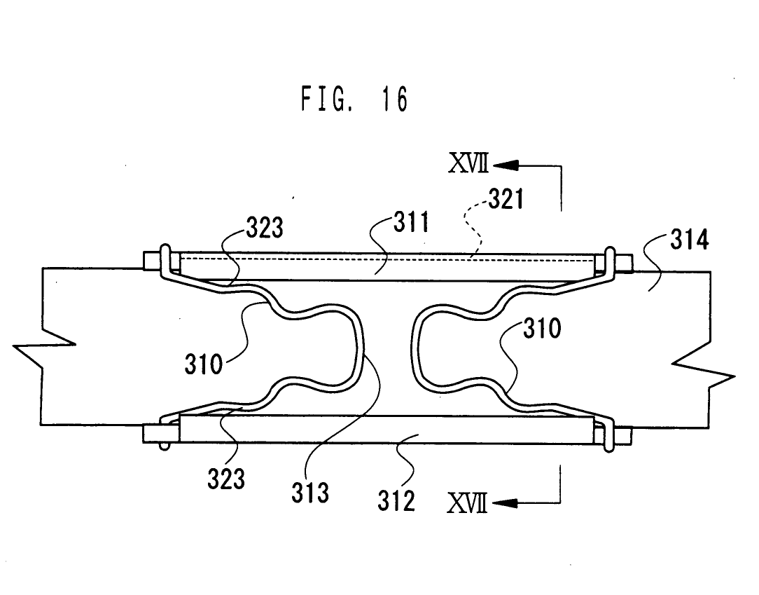

Subsequently, a seventh embodiment will be described. FIG. 19 is a back side view of a clip according to the seventh embodiment. A clip 300c employs the upper jaw 311 and the lower jaw 312 of the clip 300 according to the fifth embodiment, and resilient members 310b in which a connecting portion 313b is longer than that of the resilient member 310 of the third embodiment is used so that the thicker object can be clamped. Alternatively, as in the example shown in FIG. 5, it is also possible to change the shape of the resilient portion of the resilient member and use the configuration in which the connecting portions are located in the vicinity of the both ends of the jaw.

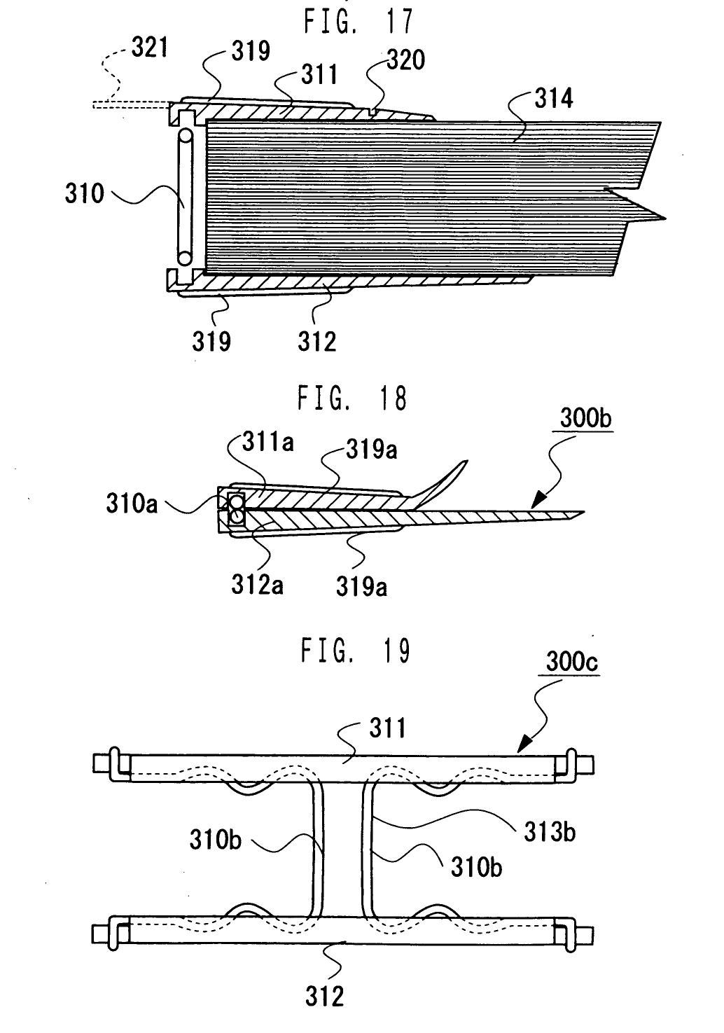

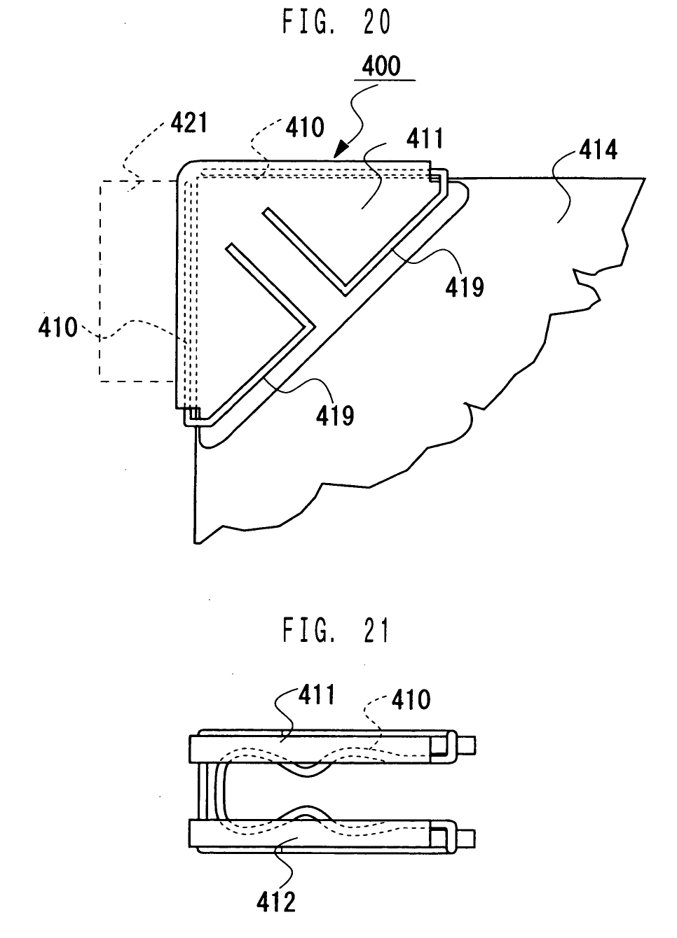

FIG. 20 to FIG. 24 are drawings showing an application of the clip using the structural principals of the various clips according to the above-described embodiments. FIG. 20 is a front view showing a first application of the present invention. FIG. 21 is a side view of the same. Since the clip in the related art has a configuration in which the upper and lower jaws rotate about the back side thereof and clamp the object, it is substantially impossible to dispose the jaws so that a right angle is formed on the back side, that is, to realize a so-called triangle corner clip.

However, according to the principle of the present invention, both of the jaws clamp the object not by rotating, but by the vertical movement. As shown in FIG. 20 and FIG. 21, by disposing two resilient members 410 along the two sides on the backsides, the clip 400 can be opened as if it were opened about the corner at the intersection of two sides on the backside. Such a triangle clip is least hindering as a document binder, and can be said to be an ideal clip. Furthermore, when an index 421 as shown by a broken line is provided, it can easily be identified and convenient when it is placed vertically in a file cabinet with a number of other documents. When employing a configuration in which four pressing portions 419 extending from the ends of the resilient member lie along one side on the front side of the triangle, and then are bent at a substantially right angle toward the corner at predetermined positions, an upper jaw 411 and a lower jaw 412 can be held adequately.

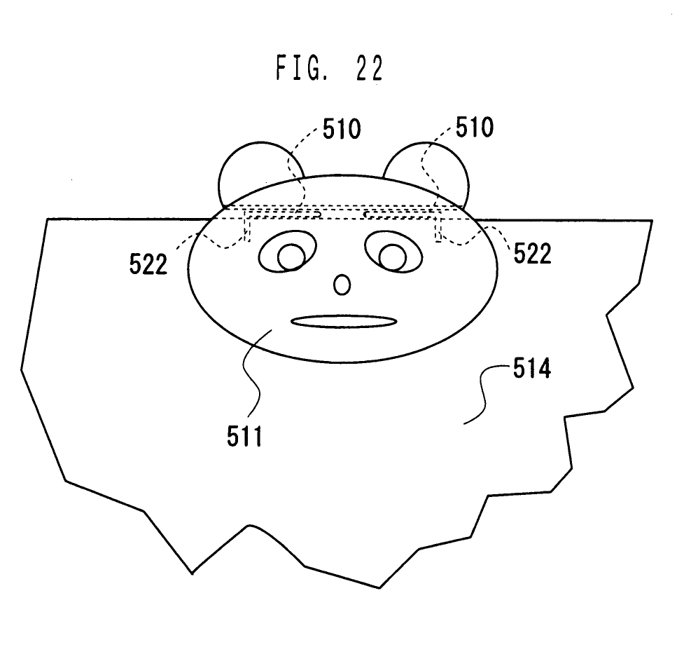

FIG. 22 is a plan view showing a second application. Since the clip in the related art has a configuration to clamp the object by the upper and lower jaws being substantially rotated, all the power points at the extremities thereof have to be at the equal distance from the fulcrum. However, according to the present invention, since the portion to clamp the object is not a limited portion as in the related art (for example, only the extremities) but is the entire jaws, the configuration is not limited as long as a force of expansion and contraction of the resilient member is transmitted to the jaws. In FIG. 22, the plan configuration of a jaw 511 is formed into a character's face. In this configuration, a function as the clip is not impaired at all from the above-described reason. In the example shown in FIG. 22, the jaw 511 is formed of plastic material, and metal wire is used as a resilient member 510. The configuration of the resilient member may be that of the third embodiment shown in FIG. 7, or may be the one provided with the jaw pressing portion as in the case of the fifth embodiment shown in FIG. 14. In FIG. 22, the resilient member as shown in the third embodiment is used, and the ends of the resilient member 510 are embedded in the jaw 511 formed of plastic to transmit the flexural rigidity.

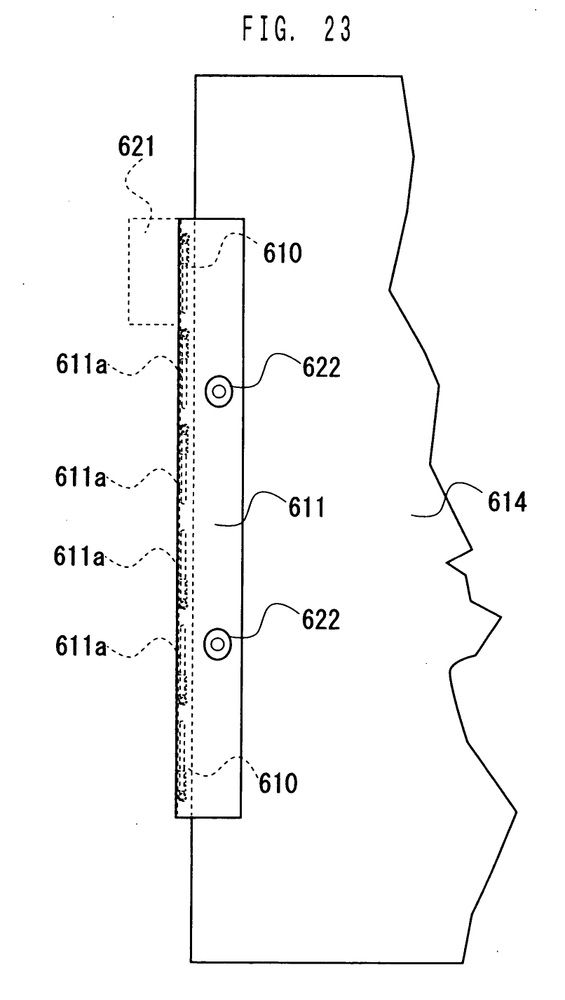

FIG. 23 is a plan view showing a third application. According to the present invention, it is not necessary to provide the useless operation portion. Therefore, a clip that does not project from the bound document more than the thickness of the jaw is achieved. In this example as well, the configuration of the resilient member may be either that shown in the third embodiment or that shown in the fifth embodiment. In addition, by selecting the configuration and the number of the resilient member, a clip having a length extending in the direction of a side of the object may be realized. For example, in FIG. 23, it is also possible to form resilient members 610, 610 at both ends as those shown in the third embodiment, and further provide another resilient member 611a at the center. It is to be understood that the length of the clip may be determined as desired by adjusting the number of resilient members, as a matter of course. Furthermore, it is also possible to store the object in a pipe file or the like, in a state of being clamped by the clip by forming binding holes 622 at predetermined positions on the clip. The index may be added as shown by a broken line 621, as a matter of course.

FIG. 24 is a front view showing a fourth application. In this example, by forming a clip board base 723 by extending the lower jaw (not shown) of the clip as shown in FIG. 23, or by mounting the clip board base 723 formed of a plate member having a size slightly larger than a paper (object) 714 to be placed on the lower jaw (not shown), a clip board in which the clip portion occupies less space in comparison with the clip board in the related art is realized. Since it does not occupy a space more than necessary, the clip boards can be stacked without being hindered by the clips and the appearance is improved. Furthermore, since it does not occupy a space more than necessary when being stored in a daily life, it does not occupy much space in the file cabinet as in the case of the product in the related art. The operating portion for facilitating clamping of the object may be and may not be provided.

The present invention is not limited to the above-described embodiments, and various modifications may be made within the scope of the invention stated in the claims. It is to be understood that those modifications are included within the scope of the invention, as a matter of course.

For example, while the ends of the resilient member are located at the ends of the upper jaw and the lower jaw, and the connecting portions are located substantially at the center thereof in the first embodiment, the third embodiment, or the fifth embodiment, it is not limited to such a configuration. FIG. 25 is a back view of a modification of the clip according to the third embodiment shown in FIG. 6 and FIG. 7. In this example, connecting portions 213b, 213b of the resilient members 210b, 210b are disposed at both ends of an upper jaw 211b and a lower jaw 212b. Devices functioning both as a clamping force transmitting portion 215b and a flexural rigidity transmitting portion 216b are provided near the center portions of the upper jaw 211b and the lower jaw 212b, respectively. In this manner, the position, the configuration, and the like of the clamping force transmitting portion, the flexural rigidity transmitting portion, and other members are not limited to the third embodiment, and various modifications in position or configuration may be applied in all the embodiments.

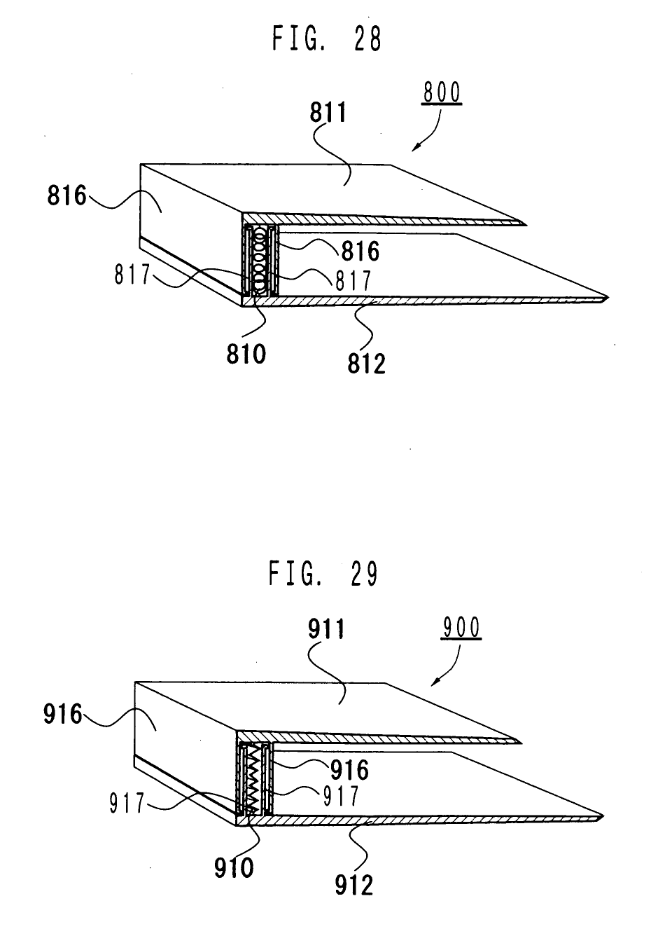

In the same manner, the configuration, the material, and the number of the resilient member are not limited to those shown in the respective embodiments. For example, it is also possible to form the jaw of resilient metal plate and machining the end thereof into a resilient member in the form of a leaf spring so as to obtain a unitary clip. While the height of the resilient member falls within the range between the upper and lower jaws, it may be higher than the range between the upper and lower jaws and protrude therefrom. In particular, although two resilient members are basically employed, the number of the resilient member may be one. Alternatively, if more than two resilient members are employed, twisting of the upper and lower jaws may be reduced, and hence the stronger structure is achieved as a matter of course. FIG. 28 and FIG. 29 are perspective views partly in cross section showing an example of a clip employing a single resilient member. In FIG. 28, the clip 800 is connected to an upper jaw 811 and a lower jaw 812 by a resilient member 810 formed of a coil spring. Vertically extending hollow members 816, 817 are provided on the back side portion of the upper jaw 811 and on the back side portion of the lower jaw 812, respectively, for transmitting flexural rigidity of the resilient member and securing rigidity against bending, and are disposed into a nested shape, so that the resilient member 810 can be stored therein. FIG. 28 shows another example in which a resilient member 910 formed of a leaf spring instead of the coil spring is shown.

The material and the configuration of the jaw are not limited to the material and the configuration shown in the examples. It is to be understood that the position, the configuration, the material, and the number of the various members such as the jaw pressing portion or the connecting portion are not limited to the exemplified embodiments. In addition, the position, the configuration, the material, the number of the clamping force transmitting portion and of the flexural rigidity transmitting portion and, in addition, the method of transmitting the clamping force and the method of transmitting the flexural rigidity are not limited to the embodiments shown as examples. In particular, the clamping force transmitting portion and the flexural rigidity transmitting portion may be provided at one location as a single device having both functions.

The opening angle between the upper and lower jaws with respect to the resilient members shown in all the embodiments may be about 90° or smaller, and the extremities may be closed as the clip in the related art. The upper and lower jaws may be curved to increase their clamping force. The operating portion, the index, the force exerting portion may be added as needed.

While four applications are shown in this specification, it is not limited thereto. For example, when a magnet is provided on the lower jaw of the clip based on the structure of the present invention, a magnet clip is obtained. When it is attached on the wall, being different from the magnet clip in the related art, the upper jaw can be maintained in parallel with the wall surface. Therefore, when the surface of the upper jaw is used as an index, since the upper jaw is not inclined as the clip in the related art, an easily-viewable indexed clip is provided.

Furthermore, when a relatively long clip as in the third application is provided instead of a binding device of a file, a file in which the document can be attached and detached easily without making holes on the document is provided. When a clip for a clip board as in the fourth application is attached on the back side of the front cover of a file, since the clip portion does not occupy a large space, even when the file is closed, the thickness does not increase. Therefore, a highly practical file having a clip board is provided.

Subsequently, an eighth embodiment of the present invention will be described. A clip according to the eighth embodiment is a type having plate-shaped upper and lower jaws as in the third embodiment to the seventh embodiment. However, in the eighth embodiment, the opposed surfaces of the upper jaw and the lower jaw are formed with a recess and a projection for clamping the object securely by the fitted or butted engagement thereof. In the third embodiment to the seventh embodiment as well, a projection and a recess as described below may be formed on the opposed surfaces (inner surfaces) of the upper jaw and the lower jaw. In the present specification, the state in which the inner surfaces are “substantially planar” is not limited to the case in which the entire inner surface is formed into a smooth single surface, but includes a case in which a projection or a recess is formed on part of the inner surface.

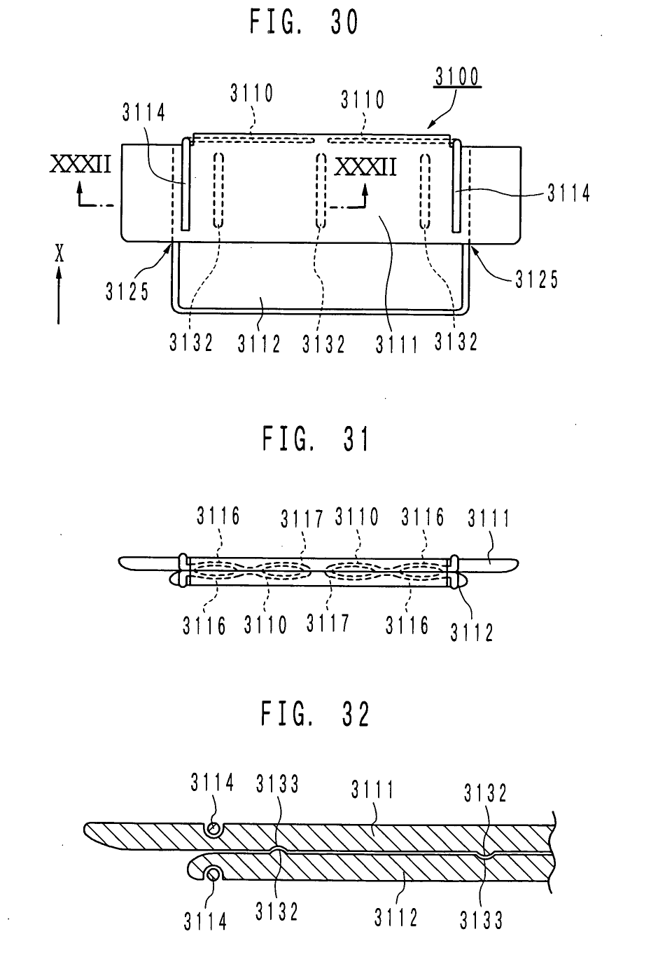

FIG. 30 is a plan view of a clip according to the eighth embodiment, and FIG. 31 is a back view in a state in which the object is not clamped. FIG. 32 is a partly cross-sectional view taken along the line XXXII-XXXII in a state in which the object is not clamped.

As shown in FIG. 30 to FIG. 32, a clip 3100 according to the eighth embodiment includes an upper jaw 3111, a lower jaw 3112, and resilient members 3110, 3110 connecting the upper jaw 3111 and the lower jaw 3112 and serving as springs. The lower jaw 3112 extends in the direction of insertion of the object (in the direction indicated by an arrow X) longer than the upper jaw 3111, and the upper jaw 3111 extends in the direction perpendicular to the direction of insertion longer than the lower jaw 3112. Therefore, an upper and lower edges intersecting portion 3125 is formed between the upper jaw 3111 and the lower jaw 3112 defined by the edges of the upper jaw 3111 and the lower jaw 3112 intersecting substantially on a plane.

On both ends of the resilient member 3110, pressing portions 3114, 3114 extending on the outer surfaces of the upper jaw 3111 and the lower jaw 3112 respectively and urging the upper jaw 3111 and the lower jaw 3112 so as to bring the upper jaw 3111 and the lower jaw 3112 closer or into tight contact with each other are formed. The resilient member 3110 includes resilient portions 3116, 3116 provided with a restoring force to align with the vertical surface defined by the edges of the upper jaw 3111 and the edges of the lower jaw 3112, and the connecting portions 3117 connecting the ends of the resilient portions.

According to the eighth embodiment, as shown in FIG. 30 and FIG. 32, a plurality of elongated recesses 3133 extending along the direction of insertion are formed at predetermined intervals on the inner surface of the upper jaw 3111, and a plurality of elongated projections 3132 extending in the direction of insertion are also formed on the inner surface of the lower jaw so as to fit into the recesses 3133, respectively. In the present embodiment, three each of recesses and projections are provided. The number of recesses and projections is not limited thereto, as a matter of course.

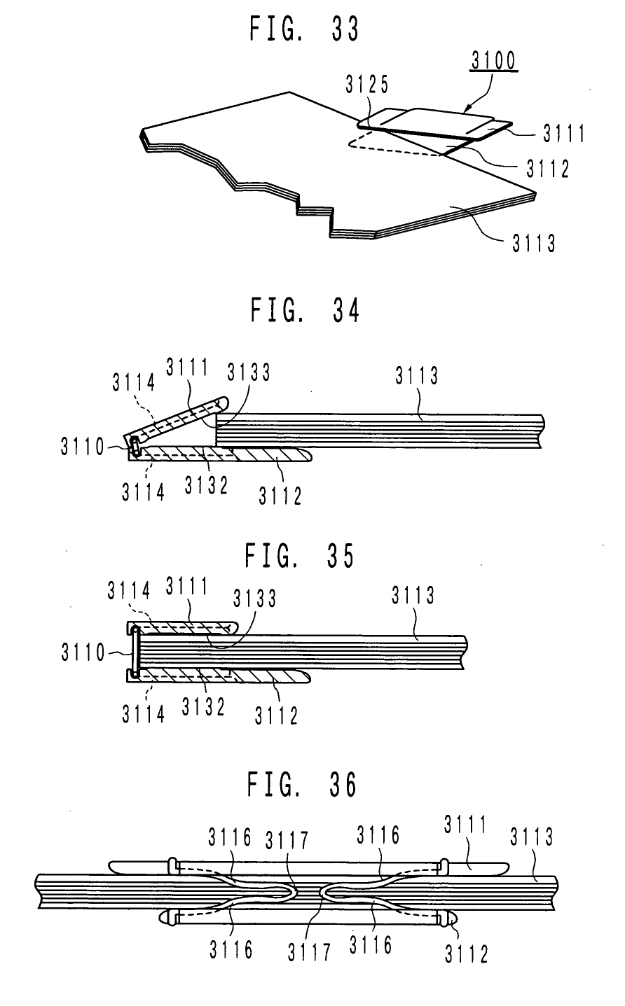

Referring to FIG. 33 to FIG. 36, a case of clamping a object 3113 using the clip 3100 according to the eighth embodiment will be described. The user first inserts the object 3113 into the clip while placing the object 3113 oriented obliquely to an upper and lower edges intersecting portion 3125, as shown in FIG. 33, and maintaining the clip in such a manner that the upper jaw 3111 comes on the object 3113 and the lower jaw 3112 under the object 3113. At this time, the clip 3100 is opened only at the extremity as shown in FIG. 34.

In this state, a force required to open the clip is not a force against the clamping force itself as in the case of the related art, but a force against bending of the resilient member 3110 having plane rigidity as shown in FIG. 34 (the resilient member is curved), which is smaller than the clamping force.

In this manner, when the distance to an extent that the object 3113 can be inserted is secured, the user pushes the object 3113 until the leading edge reaches the resilient member 3110. At this time, the thickness of the object 3113 widens the distance between the upper jaw 3111 and the lower jaw 3112 and, simultaneously, expands the resilient member 3110. When the resilient member 3110 is expanded and the height thereof is leveled with the thickness of the object 3113, the upper jaw 3111, the lower jaw 3112, and the front and back surfaces of the object 3113 are aligned in parallel with each other, as shown in FIG. 35. Then, the contracting force of the resilient member 3110 is transmitted to the upper jaw 3111 and the lower jaw 3112, and the upper jaw 3111 and the lower jaw 3112 are brought into tight contact with the object 3113, so that the object 3113 is clamped by the entire lower surface of the upper jaw 3111 and the entire upper surface of the lower jaw 3112.

FIG. 36 is a back view showing a state in which the resilient member 3110 is expanded and clamping the object 3113. As shown in the drawing, when the object 3113 is clamped, the distance between the upper jaw 3111 and the lower jaw 3112 is increased with respect to the initial state (See FIG. 31) and, correspondingly, the resilient portions 3116 of the resilient member 3110 is expanded outwardly. At this time, a force in the direction to move the upper jaw 3111 and the lower jaw 3112 toward each other is exerted by the restoring force of the resilient portions 3116, which serves as a clamping force.

At this time, the plurality of projections 3132 and the recesses 3133 fitted with each other bite into the object, so that the object 3113 is securely retained.

In the case of the clip in the related art, such projections can only be provided on the power point of the clip, that is, the linear portion at the extremity of the clip (when it is provided at the portion other than the extremity, it does not work as a power point and hence is ineffective). However, in the clip according to the present invention, the entire inner surfaces of the upper and lower jaws serve as the power point, and hence it is possible to arrange the power point not at the extremity, but in the direction substantially at a right angle with respect to the back edge as in the eighth embodiment, and in addition, it is possible to provide the plurality of projections at distance apart from each other as shown in the drawing. Therefore, it is possible to exert a strong clamping force at the plurality of power points which are located apart from each other onto the object simultaneously. Accordingly, the object can be clamped further fixedly without being displaced. In addition, in the present embodiment in which the projections and the recesses are disposed at a substantially right angle with respect to the edge of the clip, since the direction of insertion of the object corresponds to the direction of the projection, the object can be inserted easily.

The user can remove the clip 3100 from the object 3113 simply by holding the object 3113 by one hand, and pulling the clip 3100 out.

In the eighth embodiment, the elongated recesses are formed on the inner surface of one of the upper jaw and the lower jaw, and the elongated projections are formed on the inner surface of the other one of the upper jaw and the lower jaw at the position opposing to the recesses so as to fit into the recesses. However, it is not limited to such configuration, but the elongated projections may be formed on both inner surfaces. FIG. 37 and FIG. 38 are a front view and a back view of another example of the clip, respectively. A clip 3200 of this example is similar to the clip 3100 according to the eighth embodiment. However, a stronger clamping force is achieved by embedding pressing portions 3214, 3214, to which a maximum clamping force is exerted in upper and lower jaws 3211, 3212, and forming a projection 3232 on the inner surface along the portions where the pressing potions 3214 are embedded. In this example, a plurality (three in this embodiment) of elongated projections 3232 are formed on the upper jaw 3214 in addition to the above-described projections 3232.

As shown in FIG. 39, in the clip 3200, bent portions 3234 are formed at the connecting portion 3217 of a resilient member 3210 extending from the resilient portion 3216 at about 90° in the direction away from the upper and lower jaws 3211, 3212. The method of using the clip 3200 is the same as the method of using the clip 3100. In other words, the user pushes the object into the clip obliquely, and subsequently pushes the object until it reaches the resilient body 3210.

While the resilient members 3216 are apart from each other in a state in which the object is clamped, the angles at the connecting portion 3217 (the angle about 90° formed between the bent portions 3234 and the connecting portion 3217) are almost the same. That is, the angles formed by the resilient members 3216 are absorbed by twisting of the bent portions 3234. Therefore, the resilient member 3210 can be prevented from deforming locally at the connecting potion 3217 to a large extent, and hence a larger resilient area can be obtained. In other words, a clip providing better performance without becoming damaged due to plastic deformation of the resilient body 3210 even when a thicker object is clamped is obtained.

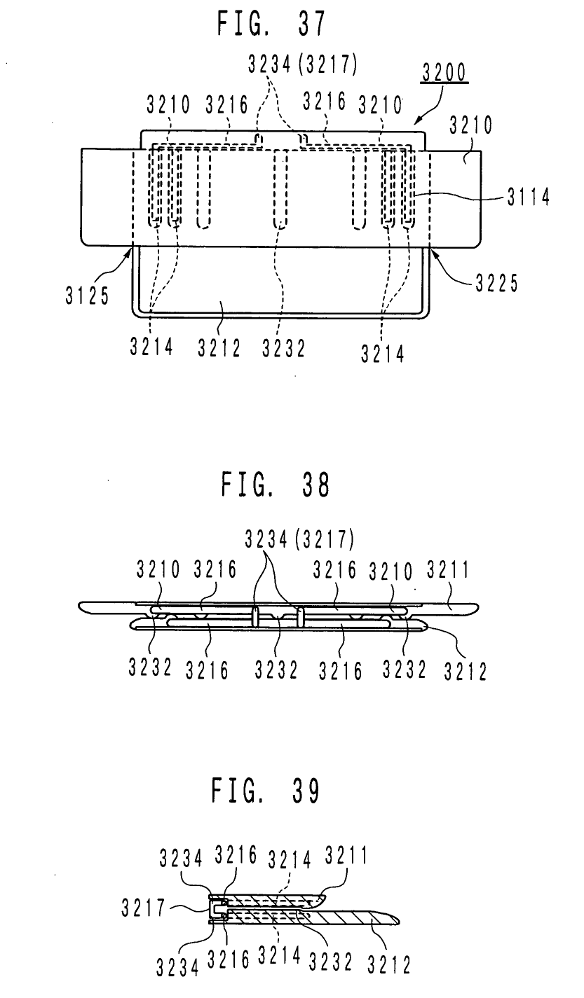

The projections and recesses as described above may be formed on the corner clip. FIG. 40 is a plan view showing an example in which projections are formed on the upper and lower jaws of the corner clip. In this clip 3300, a plurality of circular projections 3332 for preventing dropping-out are provided on the inner surface of an upper jaw 3311 and a lower jaw 3312. The projections 3332 of the upper jaw 3311 and the projections 3332 on the lower jaw 3312 are disposed so as not to oppose to each other.

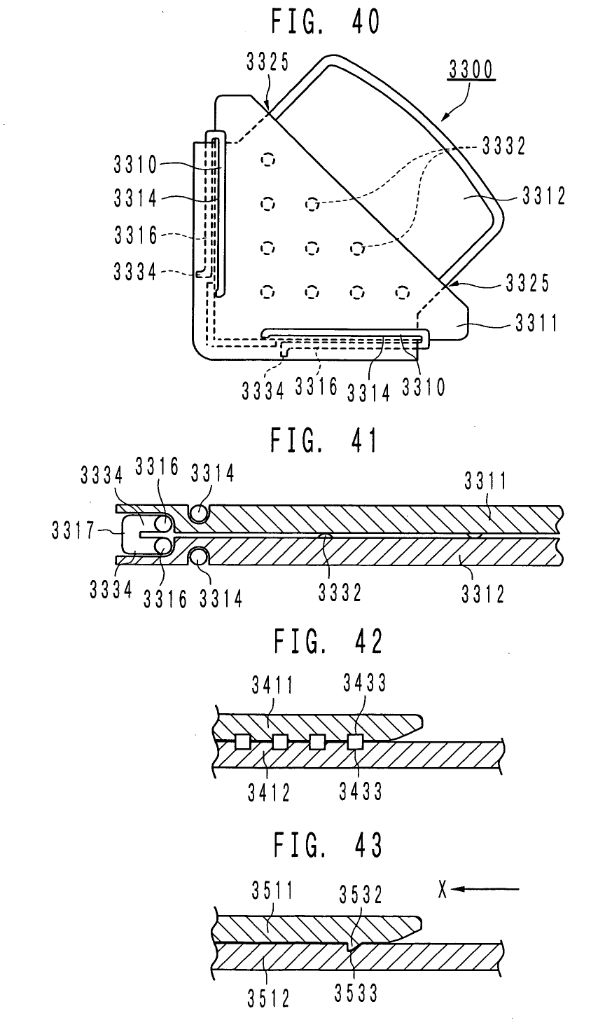

As shown in FIG. 41, bent portions 3334 extending away from resilient portions 3316 in the vertical direction are formed on the connecting portion 3317 of the resilient member 3310 of the corner clip 3300.

When using this clip 3300, the user inserts the object while placing the object oriented obliquely to upper and lower edges intersecting portion 3325 and maintaining the clip in such a manner that the upper jaw 3311 comes on the object and the lower jaw 3312 comes under the object. In this case, a force required for insertion is a force against the closing force of the resilient portions 3316, 3316. When the distance by an extent that the object can be inserted is secured, the user presses the object while rotating until the leading edge reaches the corner portion of the upper and lower jaws. At this time, the thickness of the object widens the distance between the upper jaw 3311 and the lower jaw 3312 and, simultaneously, widens the extremities of pressing portions 3314, 3314 in the direction away from each other. Then, when the distance between the upper jaw 3311 and the lower jaw 3312 at the corner portion is leveled with the object, the upper jaw 3311, the lower jaw 3312, and the front and back surfaces of the object align in parallel with each other. Then, a force to close the resilient portions 3316 and the restoring force of the pressing portions 3314, 3314 which are moved away from each other, that is, a force to move the upper jaw 3311 and the lower jaw 3312 toward each other is transmitted to the upper jaw 3311 and the lower jaw 3312, and hence the upper jaw 3311 and the lower jaw 3312 come into tight contact with each other and clamp the object between the entire lower surface of the upper jaw 3311 and the entire upper surface of the lower jaw 3312.

The projection is not limited to an elongated shape, and a circle or other various shapes (for example, a rectangular shape) may be employed. As shown in FIG. 42, it is also possible to provide recesses 3433, 3433 on both inner surfaces of the upper jaw 3411 and the lower jaw 3412. In the example shown in FIG. 42, the recesses are opposed to each other. However, it is not limited thereto, and the recesses may be provided on the upper jaw and the lower jaw so as not to oppose to each other, as a matter of course.

In addition, in the eighth embodiment, while the elongated projections and recesses are formed along the direction of insertion, it is not limited thereto, and the elongated projections and recesses may be formed along the direction perpendicular to the direction of insertion. Furthermore, it is also possible to form the elongated projections and recesses both along the direction of insertion and along the direction perpendicular thereto, as a matter of course.

As shown in FIG. 43, by inclining the cross-sectional configuration of projections 3532 formed on one of the upper and lower jaws (an upper jaw 3511 in FIG. 43) in the direction of insertion of the object (in the direction indicated by an arrow X in FIG. 43), and forming the shape of recesses 3533 formed on the other one of the upper and lower jaws (a lower jaw 3512 in FIG. 43) in the shape fitted thereto, a clip which is easy to insert the object and, simultaneously, which dose not come off easily can be provided.

According to the present invention, all the disadvantages which the clip in the related art suffers from can be solved and simultaneously, the clip having a new function, for example, a clip having flexibility in shape can be provided.

The greatest effect obtained when the clip structure of the present invention is employed is that the clip that comes tightly into contact with the document without spending a space more than the thickness of the upper and lower jaws regardless of the type of the clamped document. In particular, according to the third embodiment, the extent of the projection from the level of the document is limited to the thickness of the metal plate, and hence a smart clip which allows the user to be unconscious of the space occupied by the clip is obtained.

When employing the clip structure according to the present invention, since the clamping force is provided by a force of expansion and contraction of the resilient member, from the thin document to the thick document can be clamped only by changing the resilient body without changing the size of the jaws. Therefore, the size of the clip can be unified. In addition, since the document of any thickness can be clamped as long as the capability of the resilient member allows, provided that the thickness of the object exceeds the height of the resilient member, and hence a versatile clip can be provided.

With the clip structure according to the present invention, the user can attach the clip by opening with a small force easily without using a specific tool. In addition, the operating portion for opening the clip is not specifically required, and hence a very smart clip is provided. Furthermore, being different from the clip in the related art in which a force is locally exerted, the document is clamped by the entire surfaces of the jaws, and hence the document hardly becomes damaged.

With the clip structure according to the present invention, a clip which does not occupy a large space even when it is formed of material which is low in strength, such as plastic, is obtained. In particular, when using plastic as a jaw, a clip having various added values or functions is obtained. For example, when the jaw is formed by a transparent material, characters under the clip can be read even when it is closed, and hence a discreet and smart clip is obtained. As long as it is formed of plastic, the color may be changed and hence a colorful clip is obtained, which is useful for identification of the plurality of documents. In addition, since the upper and lower jaws are completely separated, it is also possible to provide a transparent upper jaw and a colorful lower jaw. Accordingly, as described above, the clip having a high performance such that it is discreet when viewing the document, and is distinctive easily when discriminating from many documents by the color of the jaw located on the lower side of the clip is attained. When the clip is formed of plastic that can easily be molded, it is also possible to provide an index formed integrally with the clip. In particular, in the clip of the present invention, since the jaws are constantly kept in parallel with the document, the index which is integral with the clip is also aligned in parallel with the document. Therefore, the indexed clip, which was not practical because it is inclined when the document is clamped, can be realized as a practical product.

With the structure of the clip according to the present invention, the position of the document to be clamped is not limited as the clip in the related art, and the document is clamped by the entire surfaces of the jaws. Therefore, the jaws can be formed into desired shapes. In other words, the lower jaw may be extended as shown in the third embodiment, or a design of a character can be employed as in the example shown in FIG. 22.

With the clip structure according to the present invention, the number of resilient members can be increased as needed without occupying the space larger than the thickness of the jaw. Therefore, an elongated clip for binding the document into a simple book bind is also applicable. Furthermore, a clip which can be bound in a file in a state of clamping the document can be achieved by forming loose holes corresponding to the binding device of a file as in the sixth embodiment. In addition, the clip board the jaws of which do not occupy a large space as shown in FIG. 24 is achieved.

With the clip structure according to the present invention, the jaws do not clamp the object by being rotated in one direction as the clip in the related art, but clamps by the vertical movement, whereby the corner clip, which was impossible in the related art, is also achieved.

With the clip structure according to the present invention, the clips of large size and small size can be manufactured without changing the jaws, but simply by changing the resilient member, which realize the significant reduction of manufacturing cost.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. A clip for clamping a given clamping object comprising: an upper jaw formed of a linear material to be located at least on the front surface of the clamping object, the upper jaw having a shape to surround part of the front surface of the clamping object, a lower jaw to be located at least on the back surface of the clamping object, the lower jaw having a shape to surround part of the back surface of the clamping object; and a pair of vertically expandable and contractible resilient members for connecting the end of the upper jaw and the end of the lower jaw, characterized in that the resilient member is formed so as to be positioned from the end of each of the upper jaw and the lower jaw along the backside thereof in a state in which the clamping object is clamped.

2. A clip according to claim 1, characterized in that the resilient member is formed substantially in the vertical direction on the backside.

3. A clip according to claim 1, characterized in that the upper jaw and the lower jaw are held at an angle of about 90° or smaller with respect to the resilient member when the clamping object is not clamped.

4. A clip according to claim 3, characterized in that the resilient member is provided with rigidity against bending so that the upper jaw and the lower jaw are kept at about 90° with respect to the resilient member when the clamping object is clamped.

5. A clip according to claim 1, characterized in that at least a pair of resilient members are provided, and each resilient member comprises a pair of elastic resilient portions and a connecting portion extending in the vertical direction for connecting the ends of the resilient portions.

6. A clip according to claim 1, characterized in that the upper jaw and the lower jaw each have a shape defining three sides of a rectangle.

7. A clip according to claim 1, characterized in that the upper jaw and the lower jaw each have a shape defining two sides of a triangle.

8. A clip according to claim 1, characterized in that at least the pair of resilient members are disposed at a predetermined angle.

9. A clip for clamping a given clamping object comprising:
a substantially plate-shaped upper jaw at least the inner surface of which is substantially planer;
a substantially plate-shaped lower jaw at least the inner surface of which is substantially planer; and
at least one or more resilient members connecting a part of the upper jaw and the corresponding portion of the lower jaw and which vertically expand and contract,
characterized in that the resilient member is formed so as to be positioned from the end of each of the upper jaw and the lower jaw along the backside thereof in a state in which the clamping object is clamped.

10. A clip according to claim 9 characterized in that the resilient member comprises a pair of pressing portions extending from both ends at an angle of about 90° or smaller with respect to the resilient member itself for urging the upper jaw and the lower jaw toward each other.

11. A clip according to claim 9, characterized in that the resilient member may be formed in the vertical direction on the backside.

12. A clip according claim 9, characterized in that the upper jaw and the lower jaw are held at an angle of about 90° or smaller with respect to the resilient member when the clamping object is not clamped.

13. A clip according to claim 12, characterized in that the resilient member is provided with rigidity against bending so that the upper jaw and the lower jaw are held at about 90° with respect to the resilient member when the clamping object is clamped.

14. A clip according to claim 13, characterized in that each of the upper jaw and the lower jaw is provided with a flexural rigidity transmitting portion to transmit the flexural rigidity of the resilient member by coming into contact with the resilient member at least at one point.

15. A clip according to claim 13, characterized in that rigidity against bending of the resilient members may be provided to the upper jaw and the lower jaw by bending the backside ends thereof into a nested shape.

16. A clip according to claim 9, comprising at least a pair of resilient members, each resilient member being formed of linear material and comprising a pair of expandable and contractible resilient portions and a connecting portion extending vertically for connecting the ends of the resilient portions.

17. A clip according to claim 16, characterized in that the ends of the resilient member are positioned in the vicinity of the ends of the upper jaw and the lower jaw.

18. A clip according to claim 16, characterized in that the connecting portion of the resilient member is positioned in the vicinity of the ends of the upper jaw and the lower jaw.

19. A clip according to claim 16, characterized in that at least a pair of resilient members are disposed at a predetermined angle.

20. A clip according to claim 19, characterized in that the upper jaw and the lower jaw are formed into a triangle defined by two sides forming the predetermined angle and a side connecting the ends of the two sides.

21. A clip according to claim 9, comprising a plurality of resilient members.

22. A clip according to claim 9, characterized in that a projection is formed on part of the inner surfaces of at least one of the upper jaw and the lower jaw.

23. A clip according to claim 22, characterized in that a recess is formed on the inner surface of the other one of the upper jaw and the lower jaw so as to be fitted to the projection.

24. A clip according to claim 23, characterized in that at least one elongated projection along the direction of insertion of the clamping object and/or an elongated recess along the direction perpendicular thereto is/are formed on the inner surface thereof.

25. A clip according to claim 22, characterized in that the plan shape of the projection is substantially circular shape.

26. A clip according to claim 25, characterized in that a projection is provided on one of the inner surfaces and a recess on the other inner surface, and the cross-sectional shape of the projection is inclined in the direction of insertion and the cross-sectional shape of the recess provided on the other inner surface has a shape fitted to the projection.

27. A clip board comprising: a clip according to claim 1; and a plate-shape base of a predetermined size for placing the clamping object, to which the lower jaw is mounted.

28. A clip board comprising a clip according to claim 1, characterized in that the base for placing the clamping object may be formed by extending the lower jaw to a plate shape of the predetermined size.

29. A clip for clamping an object, comprising:
a first jaw member and a second jaw member held in spaced parallel relationship by a resilient member, the first jaw member, second jaw member, and resilient member integrally formed of a linear material that is provided with rigidity against bending, the resilient member comprising expandable and contractible resilient portions that expand and contract when an object is placed between the first jaw member and the second jaw member to maintain the first jaw member and the second jaw member in spaced parallel relationship while applying a force to the object.

30. The clip of claim 29, wherein the resilient member is formed substantially orthogonal to a plane of the first jaw member and to a plane of the second jaw member.

31. A clip for clamping an object, comprising:
a first jaw member formed of a planar plate member, a second jaw member formed of a planar plate member, and a resilient member coupling a first end of the first jaw member to a first end of the second jaw member to hold the first jaw member and the second jaw member in spaced parallel relationship, the resilient member comprising a pair of expandable and contractible resilient portions that expand and contract when an object is placed between the first jaw member and the second jaw member to maintain the first and second jaw members in spaced parallel relationship while applying a force to the object to hold the clip to the object.

32. The clip of claim 31, wherein the resilient member is formed substantially orthogonal to a plane of the first jaw member and to a plane of the second jaw member.
